(19) United States
(12) Patent Application Publication
(10) Pub. No.: US 2009/0000698 A1
(43) Pub. Date: Jan. 1, 2009

(54) Suspendable tree cutter having an adjustable orientation pivot

(76) Inventor: Brian Beresford, Cranbrook (CA)

Correspondence Address: Antony C. Edwards, P.O. Box 26020, Westbank, BC, V4T 2G3, CA

(21) Appl. No.: 12/155,481

(22) Filed: Jun. 5, 2008

Related U.S. Application Data
(60) Provisional application No. 60/924,971, filed on Jun. 7, 2007.

(51) Int. Cl. A01G 23/08; A01G 23/091

(52) U.S. Cl. 144/336; 144/34.1; 144/4.1

(57) ABSTRACT

Disclosed is a method and apparatus for cutting a tree using a helicopter and a tree cutter suspended from the helicopter. The tree cutter includes a frame which is selectively orientable about a horizontal axis of rotation by an elongate member extending perpendicular to the horizontal axis. A support line from the helicopter is mounted to the elongate member. The support line may be slid to a plurality of locations along the elongate member. Each of the plurality of locations corresponds to a unique orientation of the frame. A pair of gripping arms extend from the frame. A saw is pivotally mounted to the frame so as to cut a tree secured in the gripping arms. The method includes selectively orienting and suspending the cutting apparatus proximate to a tree to be cut, gripping the tree with the gripping arms and cutting the tree with the saw.

### CROSS REFERENCE TO RELATED APPLICATION

This application claims priority from U.S. Provisional Patent Application No. 60/924,971 filed Jun. 7, 2007 entitled Suspendable Tree Cutter Having an Adjustable Orientation Pivot.

### FIELD OF THE INVENTION

The present invention relates to harvesting of trees in general and in particular to a method and apparatus for the cutting and removal of trees and logs through the use of a helicopter.

### BACKGROUND OF THE INVENTION

Methods of cutting trees down are well known. In particular the use of hand operated chain saws or saws manipulated by heavy machinery are commonly used. Both of these typical methods of cutting down trees requires access to the base of the tree. In the case of a heavy machine, such as, for example an excavator with a feller buncher head attached to the distal end of the arm requires a significant amount of free space adjacent to the base of the tree so that the excavator may access the tree.

Access to the base of a tree is not always available or practical. In the case of trees located on high or steep mountain sides, road access may not be available. In addition, in the case of thick forests where only a single tree is desired to be cut down, previous methods have required having a worker either walk to the location or be lowered to the ground from a helicopter proximate to the target tree. The worker may then cut down the tree using convention methods and the tree removed by a helicopter. This method is both expensive and time consuming.

Conventional methods of cutting down trees also suffer from the hazard associated with trees that have been at least partially cut at the base but are leaning against an adjacent tree, which are known as snags in the art. Snags are one of the largest hazards facing loggers today. The extraction of a snag requires a logger to be adjacent to the base of the snag or a supporting tree so as to cut one or both down. The resulting movement of the snag or the supporting tree during this process may cause one or more of these trees to strike the worker.

The use of mechanical harvesters or feller bunchers has reduced these risks, although for the reasons set out above, it is not always possible to use a harvester or a feller buncher in all areas. In addition, on smaller logging sites, where no large equipment is currently being used, the cost and delay of bringing a harvester or feller buncher may be prohibitive to their use.

What is desirable is a method and apparatus of cutting a tree with a helicopter which does not require a worker or machine on the ground. The method and apparatus would also desirably enable the helicopter to lift and cut a blow down or a snagged tree.

### SUMMARY OF THE INVENTION

According to a first embodiment of the present invention there is disclosed a method of cutting a tree or log (herein collectively also referred to as a “workpiece”) using a helicopter. The method comprises providing a vehicle suspendable cutting apparatus comprising a gripper, a cutter and a selective orientation means. The method further comprises selectively orienting the cutting apparatus relative to the tree or log, the gripping the tree or log with the gripper and cutting the workpiece with the cutter.

According to a further embodiment of the present invention there is disclosed an apparatus for cutting a workpiece. The apparatus comprises a frame suspendable from a vehicle such as a helicopter wherein the frame is selectively orientable about a horizontal axis. A pair of opposed gripping arms extend from the frame and are operable to selectively grip a tree or log substantially perpendicularly to the horizontal axis. A saw is rotatably connected to the frame and is selectively engageable against a tree secured in the gripping arms.

The apparatus may further comprise an elongate member extending perpendicular to the horizontal axis. The elongate member may be operable to slidably receive a support line from the vehicle wherein the support line may be received at a plurality of locations along the elongate member. Each of the plurality of locations corresponds to a unique orientation of the frame.

The elongate member may include first and second ends. Locating the support line at the first end of the elongate member may substantially align the frame to grasp and cut a substantially vertical tree. Locating the support line at the second end of the elongate member may substantially align the frame to grasp a substantially horizontal log. The first end of the elongate member may be disposed in a direction closer to a tree gripped between the gripping arms than the second end.

The elongate member may be pivotally connected the frame. The first end of the elongate member may be secured to the frame with a flexible tension member. The flexible tension member may be selected from the group comprising a rope, a cable, and a chain.

The saw may comprise a chain saw. The chain saw may be pivotally connected to the frame. The chain saw may be rotatable about the pivot so as to be operable to cut the tree or log. The chain saw may be rotatable by a hydraulic cylinder. The chain saw may be removable from the frame.

The gripping arms may be pivotally connected to the frame about parallel axes. The gripping arms may include hydraulic cylinders for moving the gripping arms towards and away from each other so as to open and close the arms.

The apparatus may further comprise a motor driving a hydraulic pump for actuating the gripping arms and saw hydraulic cylinders. The apparatus may further comprise a hydraulic reservoir. The hydraulic reservoir may include a pick-up line for the hydraulic pump on at least one side of the reservoir.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a cutting apparatus according to a first embodiment of the present invention in a horizontal orientation suspended from a helicopter adjacent to the base of a tree to be cut.

FIG. 2 is a perspective view of the cutting apparatus of FIG. 1 in a vertical orientation.

FIG. 3 is a bottom view of the cutting apparatus of FIG. 1 with the gripping arms open around a tree.

FIG. 4 is a bottom view of the cutting apparatus of FIG. 1 with a tree gripped between the gripping arms.

FIG. 5 is a side view of the cutting apparatus of FIG. 1 resting on a surface with the cable support at a first position for supporting the cutting apparatus in a horizontal orientation.

FIG. 6 is a side view of the cutting apparatus of FIG. 1 resting on a surface with the cable support at a second position for supporting the cutting apparatus in a vertical orientation.

FIG. 7 is a side view of the cutting apparatus of FIG. 1 gripping a tree with the cable at a second position for guiding the fall direction of the tree.

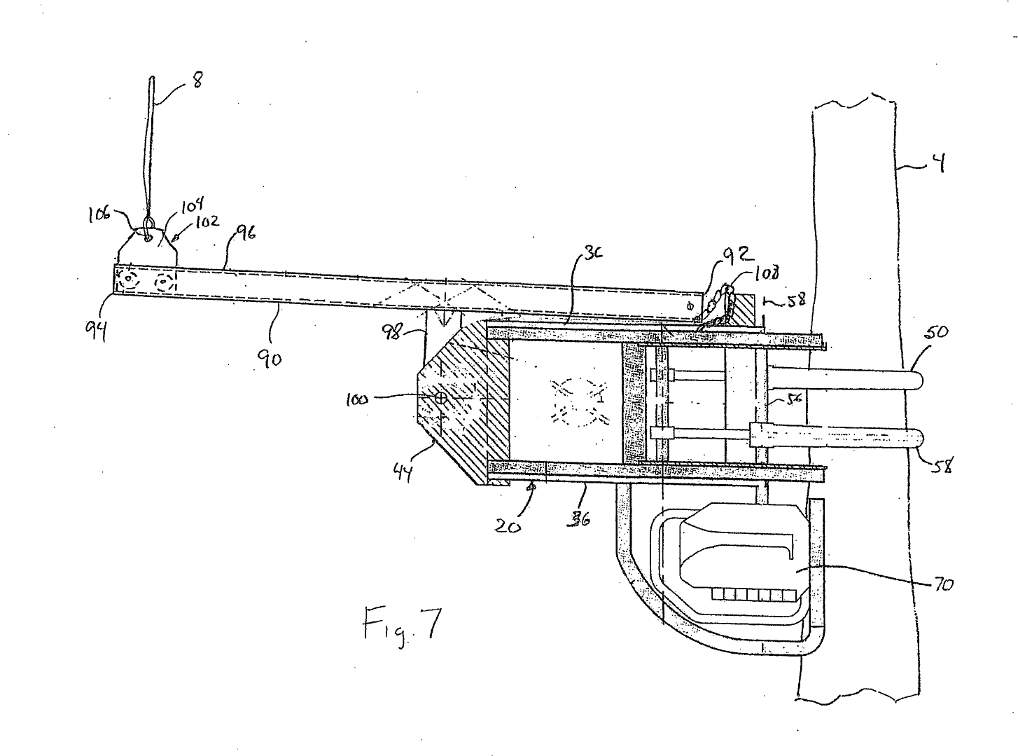

FIG. 8 is a side view of the cutting apparatus of FIG. 1 with the cable support at a second position with the cutting apparatus suspended in a vertical orientation.

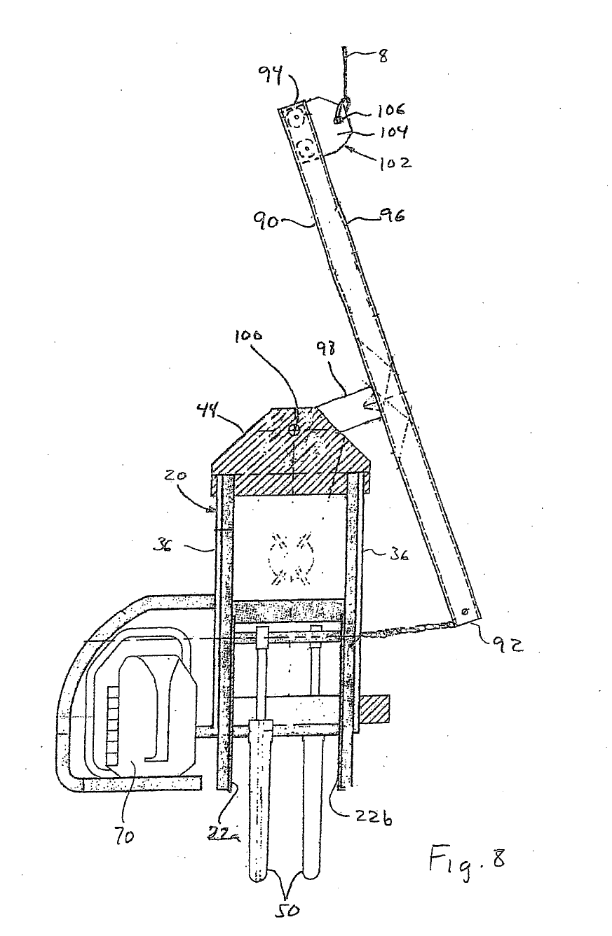

FIG. 9 is the view of FIG. 3 in an alternative embodiment employing wireless control communication.

### DETAILED DESCRIPTION OF EMBODIMENTS OF THE INVENTION

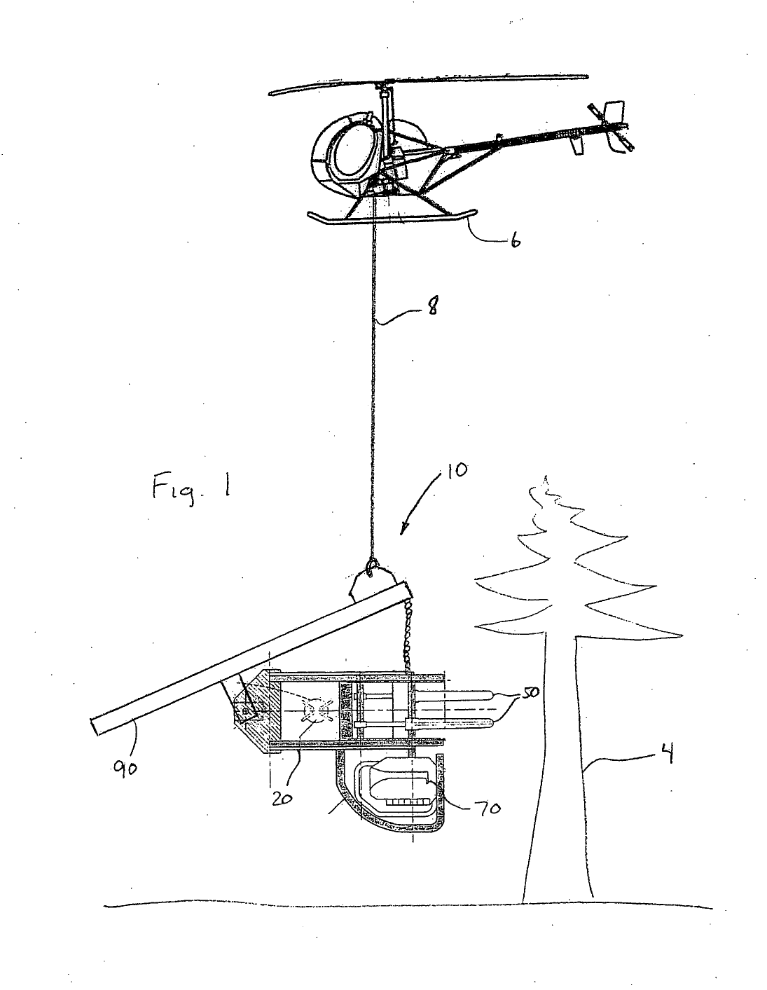

Referring to FIG. 1, a cutting apparatus according to a first embodiment of the invention is shown generally at 10. The cutting apparatus 10 is suspended on the end of a line 8 from a helicopter 6 adjacent to a tree to be cut 4. Although the cutting apparatus is illustrated as being suspended from a helicopter in the figures, it will be appreciated that the cutting apparatus may also be suspended from other aerial or airborne vehicles which may be held in a hover, but a helicopter is preferred. This allows for access into otherwise difficult to reach or difficult to navigate terrain. The cutting apparatus may be suspended by a cable, rope, chain or other suitable line 8.

The cutting apparatus 10 comprises a frame 20 having a pair of opposed gripping arms 50 and rotatable saw 70 supported thereon. As described further below, the pivotal movement of saw 70 is substantially parallel to the pivotal movement of the gripping arms 50. That is, a plane containing the movement of the saw is parallel to a plane containing the movement of the arms. The cutting apparatus also includes a pivoting slide bar 90 pivotally attached to the frame 20 wherein the end of the line 8 is slidably connected slide bar. It will be appreciated that the cutting apparatus 10 may also include control wires (not shown) extending from the cutting apparatus to the helicopter 6 for control of the cutting apparatus by a user in the helicopter. Radio frequency or other remote control means may also be useful, as better described below.

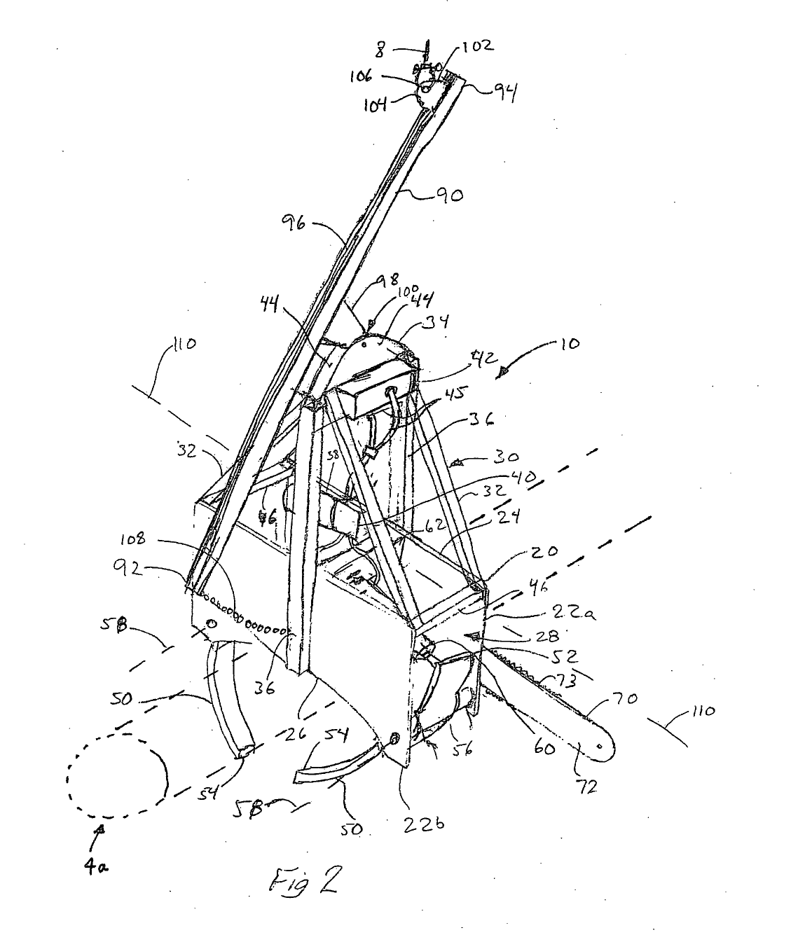

Turning now to FIG. 2, the frame 20 comprises a pair of spaced apart main plates 22a and 22b each having top and bottom edges 24 and 26, respectively and defining a space 28 therebetween. The top edges 24 are connected to a space frame 30 comprising a plurality of angled members 32 extending from the top edges 24 of the main plates 22a and 22b to a top bracket 34. The space frame 30 also includes side braces 36 extending from the top bracket 34 to the bottom edges 26 of the plates 22. As illustrated, the space frame 30 may also support a motor 38, a hydraulic pump 40 and a hydraulic tank 42 as well as hydraulic hoses 43 and solenoid valves required to operate the cutting apparatus 10 in accordance with the functioning as described below as will be appreciated by a person of skill in the art. The hydraulic tank 42 my include a plurality of fluid pick-up locations 45 on a plurality of sides of the tank so that hydraulic fluid will be available for the hydraulic pump 40 at a plurality of orientations of the cutting apparatus 10. The top bracket 34 comprises a pair of spaced apart bracket plates 44 perpendicularly aligned to the main plates 22. The frame 20 may also include a plurality of braces 46 arranged between the main plates 22 or the angled members 32 so as to provide additional rigidity to the frame.

The gripping arms 50 extend from and are pivotally mounted to the frame 20 about parallel axes 58. Each gripping arm 50 comprises a curved member having proximate and distal ends 52 and 54 respectively, and a pivot 56 intermediate the first and second ends. It will be appreciated that other shapes for the gripping arm will also be useful. The pivots 56 are located between the main plates 22 at opposite ends of the space 28 and rotatable relative thereto about axes 58. Actuators, such as for example hydraulic cylinders 60 extend between the proximate ends 52 and a central brace 62 of the frame 20. The hydraulic cylinders 60 serve to rotate the gripping arms 50 about their axes 58 so as to selectively grip therebetween a tree 4, log 4a or other object to be cut. Control of the hydraulic cylinders 60 are provided for by the hydraulic pump 40 and solenoids as will be appreciated by a person of skill in the art from the description of operation as provided in further detail below.

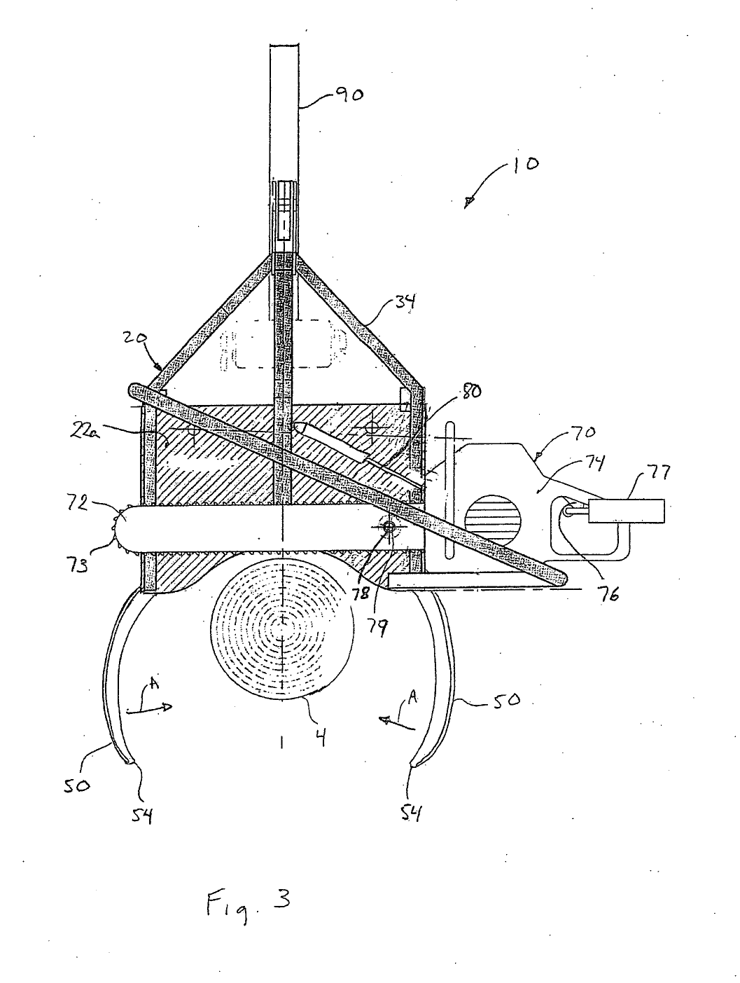

Turning to FIG. 3, a saw 70, such as for example a chain saw, is rotatably connected to the first main plate 22a. As illustrated, the saw 70 includes a bar 72 having a cutting chain 73, and a motor 74 having a throttle 76. The bar 72 of the saw 70 includes a bore 79 through which a pivot bolt 78 is passed and secured to the first main plate 22a. A rotating hydraulic cylinder 80 or other suitable means extends between the motor 74 of the saw and the first main plate 22a and serves to selectively rotate the saw about the pivot bolt 78. The rotating hydraulic cylinder may be secured to the motor 74 by a bolt or other suitable fastening means such that removal of the bolt and the pivot bolt 78 permits the saw to be removed from the cutting apparatus. This will facilitate the use of the saw by a ground personnel when not in use on the cutting apparatus 10 or when other conditions dictate. The throttle 76 of the saw 70 may include an electric solenoid 77 for remotely controlling the operation of the motor as will be described herein.

Referring back to FIG. 2, the slide bar 90 comprises an elongate member extending between first and second ends 92 and 94, respectively, a track 96 and an intermediate pivot plate 98. The track 96 comprises an open faced c-shaped channel. The pivot plate 98 extends from an opposite side of the elongate member from the track 96 and includes a pivot 100 oriented substantially perpendicular to the track and spaced apart therefrom. The pivot 100 is spaced apart from the track 96 by a distance sufficient to permit the slide bar to be rotated to substantially parallel to the side braces 36 of the frame 20. As illustrated the pivot 100 is spaced apart from the track 96 by a distance greater than half the distance between the main plates 22.

The track 96 contains a slidable carriage 102 located therein having bearings, wheels or other suitable slide means for permitting carriage 102 to freely slide within the track 96. The carriage 102 includes a connection plate 104 having a bore 106 for securing to a line 8 suspended from helicopter 6.

The first end 92 of the slide bar is connected to the second main plate 22b by a chain 108, cable or other suitable flexible securing means. The length of the chain 108 is selected to permit the slide bar to rotate away from the second main plate 22b by a distance sufficient to align the gripping arms axes 58 substantially vertical to the ground when the carriage 102 is located at the second end 94 of the slide bar.

The cutting apparatus 10 may be rotated about an axis of rotation 110 between a horizontal orientation as illustrated in FIG. 1 or a vertical orientation as illustrated in FIG. 2 by locating the carriage 102 at the first or second ends 92 or 94, respectively, of slide bar 90.

### Operation

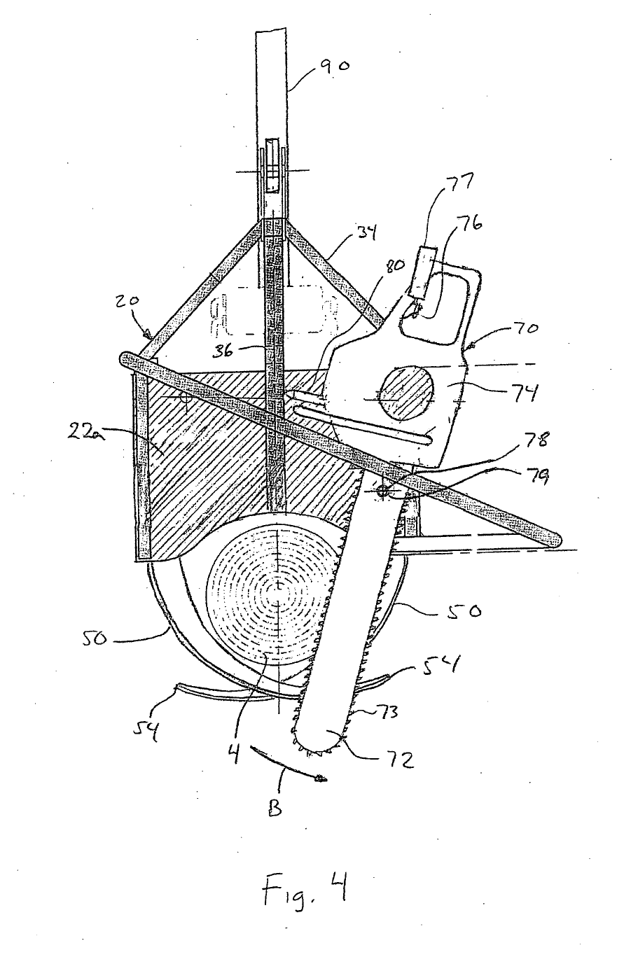

Referring to FIGS. 3 and 4, in operation, a helicopter 6 suspending the cutting apparatus 10 positions the cutting apparatus adjacent to a tree 4 to be cut. For cutting a tree, the carriage 102 is located at the first end 92 of the slide bar 90 so as to orient the cutting apparatus 10 with the gripping arms 50 substantially horizontal as illustrated in FIG. 1. The helicopter 6 positions the cutting apparatus 10 adjacent to the tree 4 with the trunk of the tree between the gripping arms 50. As illustrated in FIG. 3, the gripping arms 50 are pivoted about their axes 58 in directions generally indicated at A by the hydraulic cylinders 60 so as to be moved towards each other so as to grip the tree 4 between the gripping arms 50 and the frame 20. After the cutting apparatus 10 is secured to the trunk of the tree 4, the chain saw 70 is rotated by the rotating hydraulic cylinder 80 in a direction generally indicated at B into engagement with the tree. Solenoid 77 actuates the throttle 76 so as to bring the chain saw up to a suitable cutting speed. The rotating hydraulic cylinder 80 continues to rotate the chain saw 70 until the tree 4 has been completely cut at which time the tree held by the gripping arms 50 may be air-lifted to a suitable collection area.

As illustrated in FIG. 2, the carriage 102 may be located at the second end of the slide bar 90. In this orientation, the gripping arms 50 will extend vertically downward from the cutting apparatus 10 so as to enable the gripping arms 50 to grasp and lift an object lying on a ground or floating in water, such as for example, a log 4a or other object. It will be appreciated that this orientation will also be useful for gripping and cutting snags at a low angle of inclination.

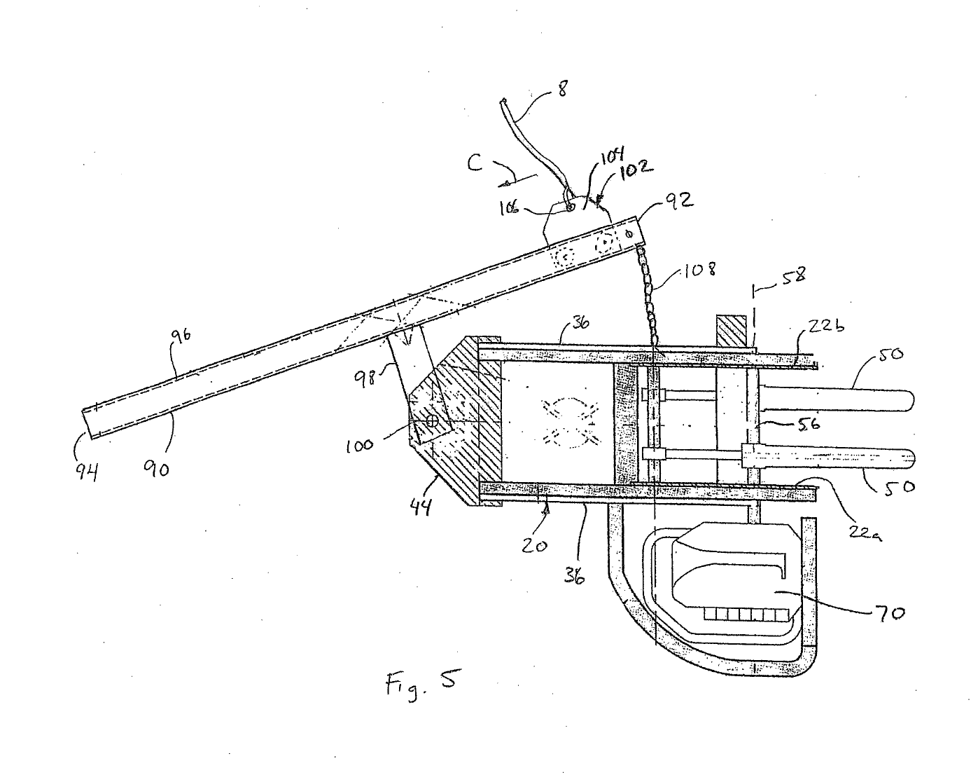

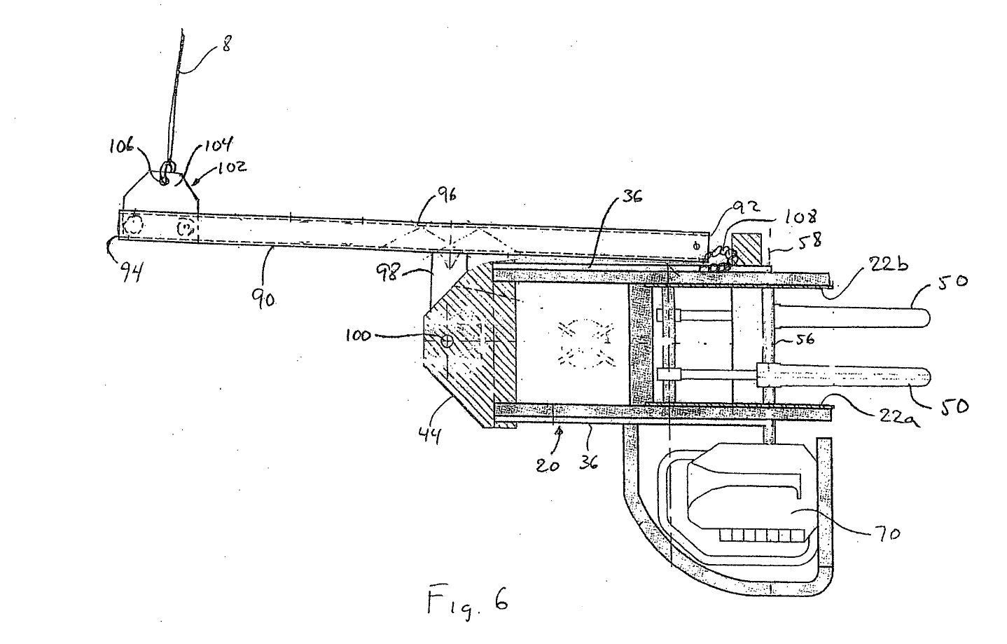

As illustrated in FIGS. 5 and 6, the carriage 102 may be moved between the first and second ends 92 and 94 of the slide bar 90 by first resting the cutting apparatus 10 on the ground. The helicopter 6 may then create slack in the line 8 so as to permit the slide bar 90 to come to a resting position. The helicopter 6 may then drag the carriage 102 in the direction of the end of the slid bar 90 that is desired for the required orientation of the cutting apparatus 10. Thereafter the helicopter 6 may lift the cutting apparatus 10 from the selected first or second end 92 or 94 of the slide bar 90 so as to lift the cutting apparatus in the desired orientation. As illustrated in FIG. 5, the carriage is moved from the first end 92 to the second end 94 of the slide bar in a direction indicated at C. It will be appreciated that the carriage may also be moved in a reverse direction.

It will also be appreciated that the cutting apparatus 10 will typically be used to grasp a tree 4 to be cut with the carriage 102 at the second end 94. After the gripping arms 50 have secured the cutting apparatus 10 to the tree 4, the helicopter 6 may provide some slack in the line 8 and slidably move the carriage 102 to the first end 94 of the slide bar 90 prior to cutting the tree with the chain saw 70 in a similar to the manner described above and illustrated in FIGS. 5 and 6. The helicopter 6 may thereafter reapply an upward lifting force through the line 8 to the second end of the carriage 102. The carriage 102 lifts up on the second end 94 of the slide bar 90 which is then pivoted about the pivot 100 until the first end 92 of the slide bar 90 rest on the side brace 36. The helicopter may thereafter apply a torque to the cutting apparatus 10 and the tree 4 a direction indicated at D. It will be appreciated that this will permit the helicopter operator to control the direction in which the tree 4 will fall by positioning the cutting apparatus 10 on the opposite side from the direction of fall and applying a torque to the tree while cutting it with the chain saw 70.

The hydraulic system of the present apparatus may include a quick release mode of operation whereby the activation of a single control by a user will rapidly and concurrently reduce the throttle of the chain saw, retract the chain saw from a cutting motion and release any object held in the gripping arms. The quick release mode may be achieved by providing a diversion valve to each hydraulic cylinder to divert the hydraulic fluid back to the hydraulic tank 42 and interrupt the pressure to the hydraulic cylinders. In addition a compressed air return reservoir (not shown) for each hydraulic cylinder may be utilized to rapidly return the hydraulic cylinders to their resting locations. They hydraulic lines for one or more of the hydraulic cylinders may also include a flow monitoring valve or a pressure control valve which is operable to divert a portion of the hydraulic fluid flow to a hydraulic cylinder when a predetermined resistance to movement of that cylinder is encountered. This will prevent the gripping arms 50 from gripping too tightly on a tree or other object and will prevent too large of a feed rate from being applied to the chain saw which may result in the chain saw stalling.

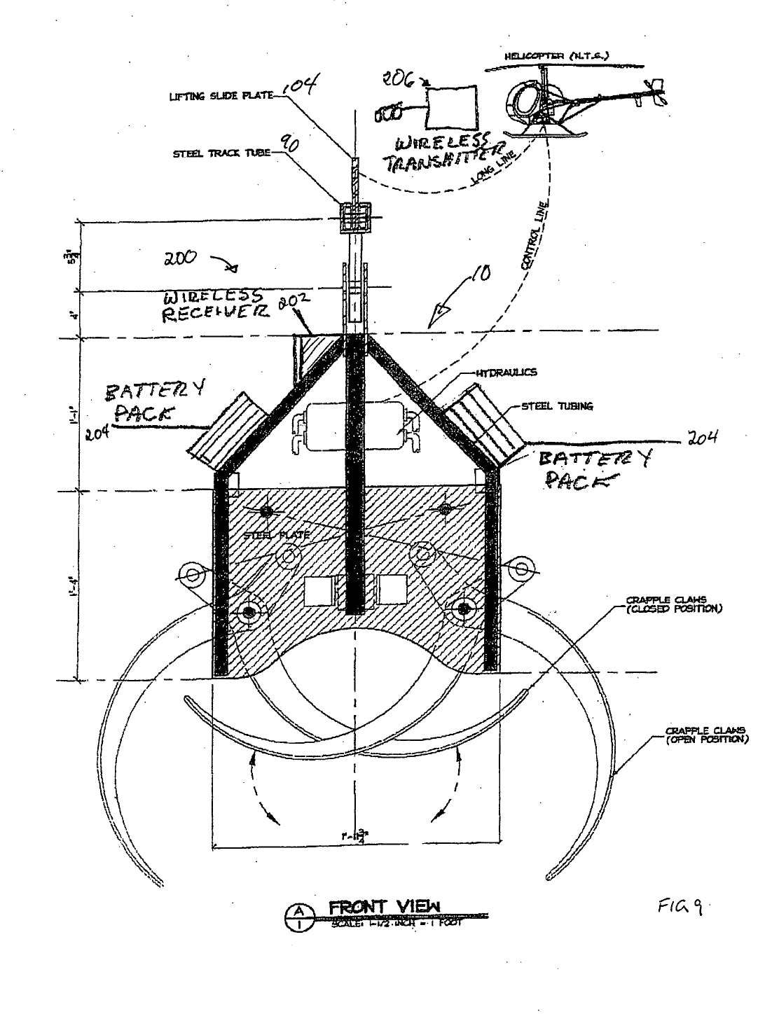

In the alternative embodiment of FIG. 9, the grapple according to the present invention includes a wireless control unit 200, which includes receiver 202 and battery packs 204, in wireless communication with transmitter 206 on the helicopter. Transmitter 206 is shown diagrammatically and enlarged in FIG. 9, it being understood that in the preferred embodiment the transmitter would be smaller and mounted to the helicopter. This embodiment then removes the need for communication and control lines from the helicopter. A preferred embodiment uses radio controls manufactured and distributed by Omnex Control System ULC, of Port Coquitlam, British Columbia, Canada, for example the Omnex™ Origa™ T100™ wireless transmitter, R100™ wireless receiver, and R100E™ antenna.

As will be apparent to those skilled in the art in the light of the foregoing disclosure, many alterations and modifications are possible in the practice of this invention without departing from the spirit or scope thereof.

What is claimed is:

1. An apparatus for cutting a tree, the apparatus comprising:
a frame suspendable from an airborne vehicle wherein the frame is selectively orientable about a horizontal axis, and wherein a pair of opposed gripping arms extend from the frame and are operable to selectively grip a tree substantially perpendicularly to the horizontal axis, and wherein a saw is rotatably connected to the frame and is selectively engageable against the tree when secured in the gripping arms.

2. The apparatus of claim 1 further comprising an elongate member extending perpendicular to the horizontal axis, and wherein the elongate member is operable to slidably receive a support line from the vehicle and wherein the elongate member is adapted to attach to the support line at a plurality of locations along the elongate member, and wherein each of the plurality of locations corresponds to a unique orientation of the frame.

3. The apparatus of claim 2 wherein the elongate member includes first and second ends, and wherein when the support line is mounted at the first end of the elongate member the frame is aligned to grasp in the arms and the saw to cut a substantially vertical tree, and wherein when the support line is mounted at the second end of the elongate member the frame is aligned to grasp in the arms a substantially horizontal log.

4. The apparatus of claim 3 wherein the first end of the elongate member is disposed in a direction closer to the tree gripped between the gripping arms than the second end.

5. The apparatus of claim 4 wherein the elongate member is pivotally connected the frame.

6. The apparatus of claim 5 wherein the first end of the elongate member is secured to the frame with a flexible tension member.

7. The apparatus of claim 6 wherein the flexible tension member is selected from the group comprising a rope, a cable, a chain.

8. The apparatus of claim 7 wherein the saw comprises a chain saw, and wherein the chain saw is pivotally connected to the frame by a pivot and selectively rotatable about the pivot by rotation means so as to be operable to cut the tree.

9. The apparatus of claim 1 wherein the gripping arms may be pivotally connected to the frame about parallel axes, and wherein the gripping arms include selectively actuable actuators for selectively moving the gripping arms relative to each other between an open-position for receiving a workpiece and a closed position grasping the workpiece

10. A method of cutting a tree comprising providing an aerial vehicle suspending a cutting apparatus comprising a gripper, a cutter and a selective orientation means from the vehicle, selectively orienting the cutting apparatus relative to a workpiece, the gripping the workpiece with the gripper and cutting the workpiece with the cutter.
